(19) United States
(12) Patent Application Publication
(10) Pub. No.: US 2003/0181201 A1
(43) Pub. Date: Sep. 25, 2003

(54) MOBILE COMMUNICATION DEVICE FOR ELECTRONIC COMMERCE

(76) Inventors: DANIEL S. BOMZE, SAN JOSE, CA (US); WILLIAM R. COCKAYNE, MENLO PARK, CA (US); NATHAN G. SCHMIDT, LONGMONT, CO (US); GEOFFREY C. PITFIELD, SAN FRANCISCO, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/351,409

(22) Filed: Jul. 9, 1999

(51) Int. Cl. H04M 3/42

(52) U.S. Cl. 455/414.3; 455/550.1

(57) ABSTRACT

A mobile device (10) for electronic commerce. The device includes a mobile housing (5A) and a microprocessor based unit (1B) coupled to a memory storage device (9B) in the housing. The device also includes a wireless receiver (5B) coupled to the microprocessor based unit. The wireless receiver is adapted to receive information comprising text and graphics from a wireless network. The receiver also has a display (4B) coupled to the housing and coupled to the microprocessor based unit. An advertisement comprising the text and graphics derived from the information also is included. The advertisement is outputted on the display.

### CROSS-REFERENCES TO RELATED APPLICATIONS

The following commonly-owned co-pending applications, including this one, are being filed concurrently and the others are hereby incorporated by reference in their entirety for all purposes:

1. U.S. patent application Ser. No. ______ titled “MOBILE COMMUNICATION METHOD FOR ELECTRONIC COMMERCE,” (Attorney Docket No. 19656-000300);

2. U.S. patent application Ser. No. ______ titled “MOBILE COMMUNICATION SYSTEM AND COMPUTER CODE FOR ELECTRONIC COMMERCE,” (Attorney Docket No. 19656-000400); and

3. U.S. patent application Ser. No. ______ titled “MOBILE COMMUNICATION USER INTERFACE DEVICE FOR ELECTRONIC COMMERCE,” (Attorney Docket No. 19656-000500)

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

The present invention relates generally to a mobile electronic communications. More particularly, the present invention provides a technique including a method for advertising using a mobile communication device. Advertisements can be derived from sources that are regional, national, or global, or any combination thereof for sales of goods and/or services. In an exemplary embodiment, the advertisements include revenues, which are used to fund periodic service fees for a user's service for the mobile communication device. Merely by way of example, the present communication technique can also be applied to other fields such as business applications, electronic commerce, consumer safety, finance, and the like.

Telecommunication techniques have been around for many years. In the early days, people often communicated to each other through airways by way of carrier pigeons. Communication using carrier pigeons was somewhat successful, but a limited amount of information, which was often imprinted on a small piece of paper attached to a pigeon's leg, could be transferred between users. A pigeons is generally small and could not carry a great deal of information while still being able to achieve flight. Additionally, pigeons had to be trained, and eventually died, which required more training and more pigeons to carry out ongoing communication services. Pigeons were also messy and often became nuisances in large cities. Accordingly, pigeons had to be replaced, at least in part, by other forms of communication means.

American Indians relied upon “smoke signals” to communicate to each other over geographic regions. Smoke signal communication could be successful on clear, windless days, but generally suffered from many limitations. Wind or rain often reduced any ability to provide clear smoke signal communication from one Indian village to another. Additionally, smoke signals often required a fire, which was often difficult to make on wet, rainy days. Fire also lead to uncontrolled forest fires, which were generally undesirable. Furthermore, smoke signals relied upon limitations of human vision, which could only see signals from smoke over a few miles or so.

Smoke signals and carrier pigeons were soon replaced by a communication technique known as telegraph. Telegraph generally transferred information from one geographical location to another geographical location using electrical signals in the form of “dots” and “dashes” over transmission lines. An example of commonly used electrical signals is Morse code. Telegraph has been, for the most part, replaced by telephone. The telephone was invented by Alexander Graham Bell in the 1800s to transmit and send voice information using electrical analog signals over a telephone line, or more commonly a single twisted pair copper line, which is a form of land line communication. Most industrialized countries today rely heavily upon telephone to facilitate communication between businesses and people, in general.

Wireless communication techniques have replaced, in part, some of the land lined based communication systems. These wireless communication techniques include cellular phones, radios, pagers, and the like. Conventional wireless communication techniques are generally limited in the way and type of information they transfer. That is, these wireless communication techniques are limited to transferring voice. There are some techniques that transfer news information such as weather, sports, and the like to a user. These techniques are often expensive, and have been limited in success. A user of such wireless technique often would like such news information, but does not way to pay the periodic service charge for it. Accordingly, conventional wireless techniques are often limited in the amount of usable information other than voice they transfer.

Therefore what is needed is mobile communication technique that utilizes wireless transfer of information which overcomes the problems and disadvantages associate with conventional device and wireless systems.

### SUMMARY OF THE INVENTION

According to the present invention, a technique including a method for using a mobile communication device is provided. In an exemplary embodiment, the present invention provides a technique for using advertisements as a source for funding a portion of the user's service. By way of the present technique, numerous mobile units will be distributed and used throughout a selected region or nationally or globally.

In a specific embodiment, the present invention provides a mobile device for electronic commerce. The device includes a mobile housing and a microprocessor based unit coupled to a memory storage device in the housing. The device also includes a wireless receiver coupled to the microprocessor based unit. The wireless receiver is adapted to receive information comprising text and graphics from a wireless network. The receiver also has a display coupled to the housing and coupled to the microprocessor based unit. An advertisement comprising the text and graphics derived from the information also is included. The advertisement is outputted on the display.

In an alternative embodiment, the present invention provides a mobile communication device. The mobile communication device is free of a service charge to a user of the mobile communication device. The device has a mobile housing, and a microprocessor based unit coupled to a memory storage device in the housing. The device also has a wireless receiver coupled to the microprocessor based unit. The wireless receiver is adapted to receiver information comprising text and graphics from a wireless network. The device also has a display coupled to the housing and coupled to the microprocessor based unit. The device further has an advertisement comprising the text and graphics derived from the information and outputted on the display. The advertisement is stored in the memory storage device. A control device in the mobile housing is also included. The control device is coupled to the microprocessor. The control device is adapted to remove the advertisement from the memory storage device as the user desires. The advertisement is derived from an advertisement server, which outputs the advertisement to pay for a portion of a service fee to a user of the mobile communication device.

Numerous advantages or benefits are achieved by way of the present invention over conventional techniques. In a specific embodiment, the present invention provides a rich and wide variety of advertisements to a user. The user can access these advertisements without a periodic service charge or fee for use of the present wireless network system. Additionally, the present invention provides an easy to use and easy to maintain wireless device and method. Furthermore, the present invention provides directed advertisements to users, depending upon the user's profile, which can be stored in a memory device such as a database. Moreover, the present invention should lower networking costs to a user, making any recurring or per-data charges lower, or reducing or eliminating recurring or per-data charges altogether. Still further, the present invention provides for other applications such as business, finance, personal, and the like. Depending upon the embodiment, one or more of these advantages may exist. These and other advantages are described throughout the present specification and more particularly below.

Other forms, implementations, and methods, advantages and novel features of the present invention will become apparent from the following detailed description of the invention when considered in conjunction with the accompanying drawings, figures, and flow diagrams.

### BRIEF DESCRIPTION OF THE DRAWINGS

FIG. 1 is a simplified block diagram of a mobile communication device according to an embodiment of the present invention;

FIGS. 1A and 1B are simplified block diagrams of a paging device according to embodiments of the present invention; and

FIGS. 2-6 are simplified flow diagrams illustrating methods according to embodiments of the present invention

### DESCRIPTION OF THE SPECIFIC EMBODIMENTS

According to the present invention, a technique including a method for using a mobile communication device is provided. In an exemplary embodiment, the present invention provides a technique for using advertisements as a source for funding a portion of the user's service. By way of the present technique, numerous mobile units will be distributed and used throughout a selected geographic region, nationally, or globally. In other embodiments, the present invention provides a novel technique for providing advertisements over a wireless network to a mobile communication device.

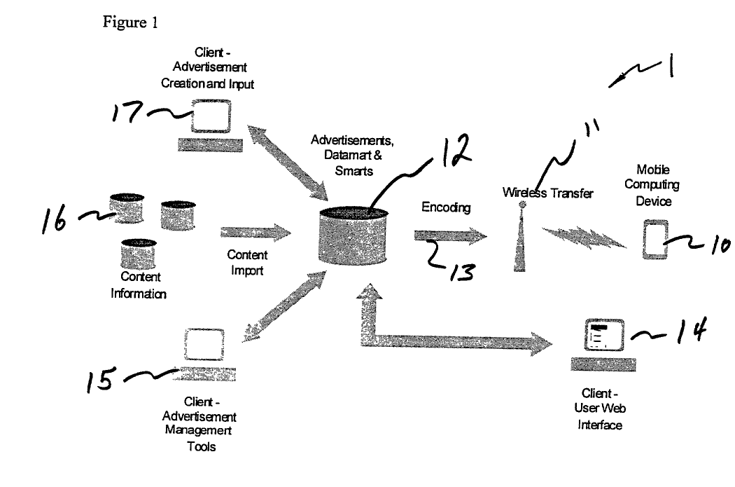

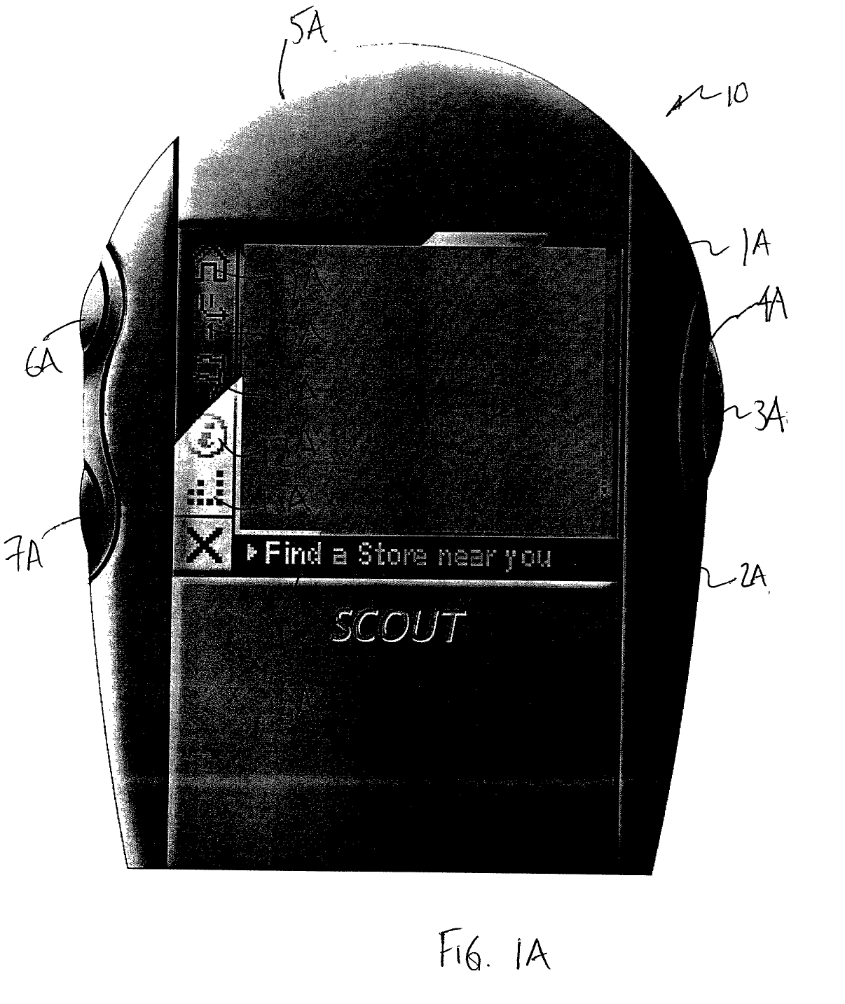

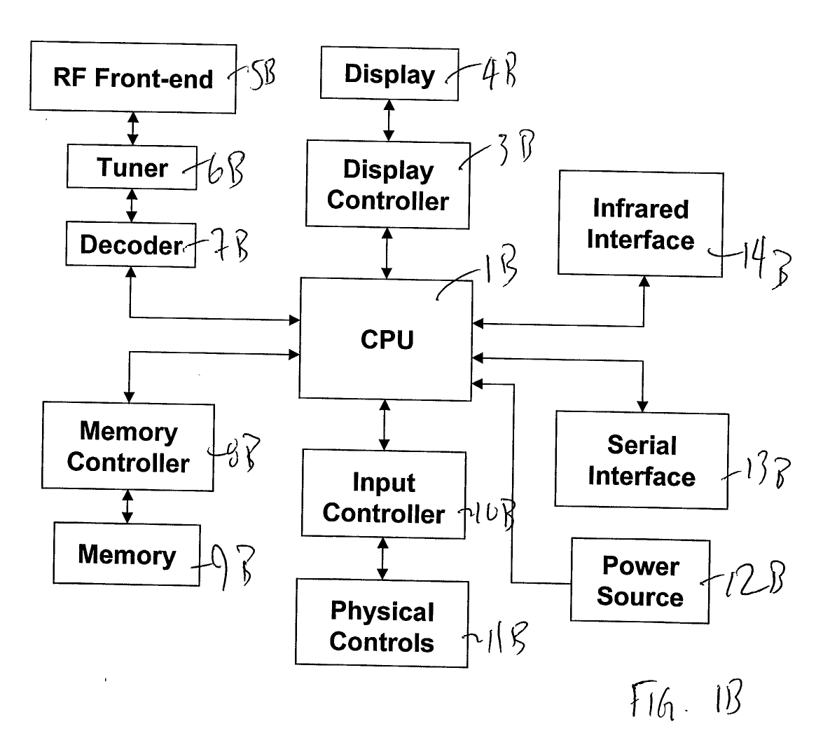

FIG. 1 is a simplified block diagram 1 of a mobile communication device according to an embodiment of the present invention. This diagram is merely an example, which should not limit the scope of the claims herein. One of ordinary skill in the art would recognize many other variations, modifications, and alternatives. The diagram 1 includes a variety of features such as a mobile communication device 10 which couples to a server (or database) 12. The mobile communication device has a memory storage device, a processor, operating instructions, a wireless receiver or transceiver, display, and input controls.

As shown in more detail in FIGS. 1A and 1B, the mobile device includes a housing 5A, which houses a display 1A. The housing also includes switches or buttons for providing operation to the device. Here, the buttons include buttons 3A, 6A, and 7A. In a specific embodiment, each of the buttons is provided into the housing with a seal 4A, which prevents moisture or other impurities into the housing. The housing is often made of a suitable resistant material to mechanical, chemical, thermal, or electrical influences. The housing includes the display, which has a browser device. The browser device has a plurality of icons, which are used for selections. The browser device includes selection 9A, 10A, 11A, 12A, and 13A. The browser device also includes a region 8A for an advertisement, which can be displayed and deleted. The browser also many other features, which are described herein.

The mobile device also includes hardware and software components in the housing. As shown, the hardware components generally include a central processing unit 1B. Here, the processor should be sufficient to operate and process a discrete amount of information. Other functionality of the mobile communication device are also overseen by the processor. The processor can be a microprocessor, a digital signal processor, a microcontroller, or the like. The processor includes a clock speed of about 2 MIPS and greater or about 100 to about 500 to about 1,000 MIPS and greater. As merely an example, the processor is a Motorola M*Core 2080 product made by a company called Motorola, but can also be others. Alternatively, the processor can be one made from a company called NEC Corporation and others. Of course, the type of processor used depends upon the application.

The processor oversees and couples to a variety of elements. The elements include, among others, a display 4B which couples to the CPU through a display controller 3B. Physical controls 11B such as those buttons noted couple to the CPU through input controller 10B. The CPU also couples to a memory device 9B through a memory controller 8B. In a specific embodiment, the memory device should have a suitable amount of memory capacity. Here, the memory device includes at least one megabytes, or four megabytes, or sixteen megabytes, or sixty-four megabytes of programmable memory. Here, the programmable memory can be selected from a suitable lower power memory with high capacity such as a dynamic random access memory (“RAM”), a static random access memory (“SRAM”), a “Flash” memory, and/or a ferroelectronic random access memory (“FRAM”). According to the present invention, the memory should include enough memory to operate while not incurring large costs.

The CPU and other elements derive power from power source 12B. The power source is often a suitable battery, which can be rechargeable. The battery can also be disposable. The CPU communicates to external devices through a variety of interfaces. The interfaces can include, among others, a serial interface 13B and a infrared interface 14. Other types of interfaces such as voice, parallel, and the like can also be included. The CPU receives (and transmits signals) an rf front end 5B, which couples through a tuner 6B and a decoder 7B. The CPU can also couple to other elements in other ways.

In a specific embodiment, the rf front end generally receive a wireless signal that contains advertisement information from a wireless broadcast unit 11, which is also coupled to the database. The wireless signal utilizes an RF or IR protocol, but can also be others. The wireless broadcast unit can be in the form of a cellular disk, a satellite disk, a totem pole, and others. The wireless signals can be from an RF network, which is made by Motorola, but can also be others. In a specific embodiment, the wireless broadcast unit transfers the advertisement information to the device on an individual, a group, or a wide scale broadcast. The advertisement information is transferred to the wireless transfer unit from the backend database or web server 12, as noted. In an embodiment, the information can be formatted for transmission using data movement and encoding tools, 13.

In another aspect, the advertisements can also be viewed by the mobile communication device user operating another device utilizing a browser 14. As merely an example, the user views the advertisements on a smart phone, smart pager, or in another form of advertising browser. The advertisements are managed, formatted, or modified at the back end utilizing tools operating on a personal computer, either within a network browser or standalone 15. The advertisements are correlated with other information that is obtained from external sources 16, that is stored on 12 as well as being generated on 14, 15. The advertisements can also be created, entered, or modified on a computer utilizing a network browser or standalone code that is utilized directly by the advertising purchaser 17. Further details of the present system are provided below.

The present invention also provides techniques for creation, aggregation, modification, formatting, compression, encryption, transfer, wireless transmission, receipt, decompression, verification, processing, storage, display, and removal of the advertisements from the mobile communication device. The advertisement system is primarily composed of a set of backend software data creation and manipulation tools, a backend storage system, such as a database or web server, a set of tools for performing the necessary manipulations of the information for transfer to the mobile communication device, a wireless network for the transfer of the advertisements, and the mobile communication device. The mobile communication device utilizes the components to operate on the advertisements to facilitate their display to the user.

The wireless receiver or transceiver of the device receives the wireless signal, which is then processed by the decoder, which could be integrated into the processor or could be a separate chip that is used is used in conjunction with the processor, then transfers the advertisement to the processor, which utilizes its operating instructions, written in a standard computer language such as assembly, C, C++, Java, Pascal, Visual Basic, Perl, etc., to verify the advertisement using digital encryption, signature, or copyright techniques, and to process any meta information related to the advertisement, such as where to place it in the memory storage area or what other information it should be displayed in conjunction with, for example having an advertisement for a restaurant being displayed to the user when the user is looking for restaurants, and then placing the advertisement and related information into the memory storage area for later display to the user. The advertisement can later be retrieved from the memory storage area by the processor and presented to the user on the mobile communication device's display when the user is looking for information correlated with or directly related to advertisements.

In a specific embodiment, the mobile communication device is provided with a radio frequency tuner and antenna systems so as to communicate via a wireless radio frequency connection with the external systems which can then transfer information to the mobile communication device. In this manner, the mobile communication device can use utilize a tuner to monitor frequency modulation (“FM”) or amplitude modulation (“AM”), ERMES, POCSAG, PCSAG, FLEX, ReFLEX, RAM, GSM, PCS, PHS, CMDA, TDMA, 3G, Bluetooth, Piano, Jini, etc, to select a particular frequency to be monitored. The mobile communication device can thus discriminate the frequency spectrum in order to detect the monitored frequency for communication with the mobile communication device. The tuner can support the ability to monitor and search through a statically or dynamically defined frequency space in order to find and utilize the exact frequency that the data is being transferred on. The device can utilize multiple tuners to support the receipt of information on multiple incompatible networks, thereby providing more extensive coverage for the wireless signal data; the incompatible networks operating in the same, partially overlapping, or totally distinct frequency spaces.

In a specific embodiment, the mobile communication device can have an area of insertion for a memory storage device, such as a smart card, smart coin, or memory stick, etc, to provide the device with advertisements, additional information on how to obtain or correlate advertisements over the wireless network, or other types of information that can be used by the mobile communication device for display to the user. Further this memory storage device can contain new versions of the code required to operate the mobile communication device or to change the application code on the device.

In a specific embodiment, the mobile communication device can utilize internal code or code added to the device through the use of a memory storage device to act as a debit card, credit, or barter system. In this configuration, the device carries the requisite information to verify the identity of the user using a secure method such as encryption or signatures and to support financial transactions by the user. The device could also contain the required information to allow for the further verification of the user, which then allows the user to perform transactions. Other possible formats for information that the device would carry for verification are encoded voice data for the user, physical encoding characteristics such as fingerprint information or optical verification, as well as digital signatures to verify and secure this and any other stored information. In this example, the identity of the user and the associated financial information such as a credit card number would be held on the mobile communication device and would be transferred by the device to the second party in the transaction is the company with which the financial transaction is being consummated.

A further embodiment of the of the method supports the use of the mobile communication device to function as a credit, debit or barter system that contains routing and verification information that allows the mobile communication device to act as a personal key between the second party or company with which the transaction is being performed and the user's financial institution or responsible third-party. The device can act as a key to be referenced during the setup, actual transaction, and tear-down between the two above systems, or could act as the conduit between the two systems allowing for another possible layer of inter-mediation between the two establishments. The device would also contain information that allows for verification of the information being presented to multiple parties based on a secured and trusted third-party system.

In a further specific embodiment, the mobile communication device is provided with only a minimal amount of memory or processing power or a different wireless receiver or transceiver, such that the device can be manufactured and sold at low cost. The device can then be sold to the consumer at a lower cost or given away to the consumer such that the costs associated with the device itself are covered by the receipt and display of advertisements by the device. In this embodiment, the user is more prone to purchase or accept and use the device in normal activities in return for allowing additional advertisements to be displayed. The general population will see a higher level of acceptance due to the lowered or non-existent cost associated with the use of the device and the information that is presented thereon.

In a further embodiment, the wireless transfer of advertisement information to the device can be performed on an individual, group, or broadcast basis. Alternatively, the wireless receiver or transceiver can actually by composed of multiple components such that the wireless information can be transferred to the device over multiple radio frequencies, multiple protocols, utilizing different carries (inter-carrier) in different regions (intra-country or inter-country), or using infrared. The advantage of this configuration is to allow the mobile communication device to be transported throughout multiple regions or countries which utilize different frequencies, protocols, methods, or companies to support wireless transfer of information and advertisements.

In a specific embodiment, the receipt, display, and later removal of advertisements from the wireless network for viewing by the user supports the wireless costs associated with an electronic commerce transaction performed on the mobile communication device over a wireless or wired network which may not allow for the advertisements to cover the recurring or per-packet charges of all of wireless data. In the model, the user utilizes the mobile communication device and the associated wireless network to contact an electronic commerce company and all information transferred over the network from or to the device is paid for by the electronic commerce company or its associated proxy partners in return for the transfer and display of advertisements maintained by the electronic commerce company. For example, an electronic commerce company can measure the amount of data that is transferred to the mobile communication device as it leaves the electronic commerce site and calculates the probable, predicted, or exact costs associated with the wireless transfer of this information to the user. Continuing the example, electronic commerce company can track this cost to the user and apply credit to the user's associated online account (with the electronic commerce company or the wireless network provider) or apply this credit to the user's next purchase as facilitated by an online payment system using debit or credit systems.

In yet another embodiment, the wireless receiver or transceiver can be supported coupled with a wire connection, serial, Ethernet, etc., for the transfer of advertisements to the mobile communication device. Utilizing the wire network, the mobile communication device operates as if the advertisements are being received from the wireless network, taking into account the different power, connection, and protocol requirements and allowing for additional operations to be performed on the advertisement information to allow for verification of the information being transferred to the device.

A further embodiment allows for the display of the advertisements or related advertisements to the user of the mobile communication device while the user is operating on another networked system, such as a computer utilizing a browser, a handheld computer utilizing a browser, a pager receiving wireless information, a cell phone receiving a wireless signal, or a smart phone receiving a message or utilizing a browser, etc. Further details of the present invention will be described in reference to the Figs. below. These details are carried out using a combination of hardware and/or software, which includes computer codes, for example.

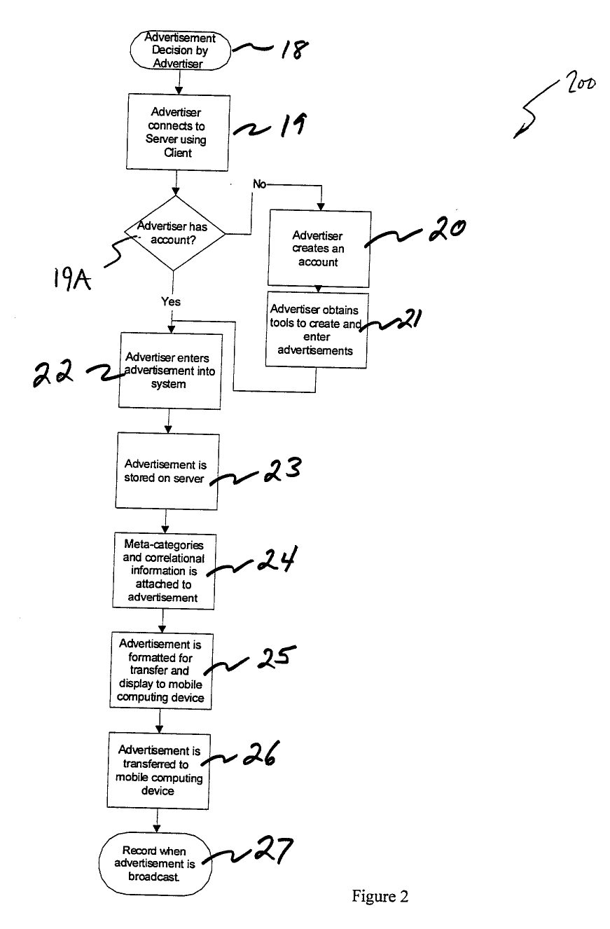

FIGS. 2-6 are simplified flow diagrams illustrating methods according to embodiments of the present invention. The diagrams are merely examples, which should not limit the scope of the claims herein. One of ordinary skill in the art would recognize many other variations, modifications, and alternatives. Referring to FIG. 2, which relates to a method 200 for the creation and addition of an advertisement to the backend system and the further packaging and transfer of the advertisement to the mobile communication device network, the advertiser decides (step 18) to put an advertisement on the mobile communication device. The advertiser interfaces with the backend system using a computer, telephone, human intermediary, etc., where a connection (step 19) is established. The connection can use a modem protocol or TCP/IP protocol or the like.

Once the connection is established, the present method has at least two routes 19A, depending upon whether an account has been established. If the advertiser does not have an account with the company operating the backend system then the advertiser utilizes the appropriate method for the interface to create an account for creation, storage, modification, removal, and payment or crediting of the account, step 20. The advertiser then obtains (step 21) the appropriate tools needed to perform actions appropriate to the account, the information being comprised of phone numbers, software, mobile communication device, information movement, advertisement management, account management, and other related tools. Next, the method continues to the following steps. Alternatively, if an account had been established, the method skips the account formation process and continues.

The advertiser enters the desired advertisement and related information into the backend system through the provided interface, step 22. The advertisement in digital form is stored in the backend memory storage systems, for example a database, step 23. The advertiser or the backend host company adds metacategorizational and correlational information to the advertisement in the memory storage system 24, such as the positioning of the advertisement in relation to the already existing content, the planned presentation of the advertisement dependent or independent of the user's actions on the mobile communication device, etc.

The backend system utilizes employees of the backend hosting company or automated tools to format and package the advertisement and its related information for transfer to the network for further transfer to the mobile communication device, step 25. The formatted and packaged information is then transferred to the mobile communication device over the network 26. In a specific embodiment, the mobile communication device receives the advertisement and the related information in a wireless radio packet format and FLEX paging protocol. Other protocols can also be used, depending upon the application. The transfer of the advertisement is recorded 27 for later tracking, auditing, and payment or crediting from the advertiser.

Although the above has been described in terms of general hardware and software, many other variations, alternatives, and modifications can exist. For example, any of the functionality above can be further integrated or even separated in terms of hardware. Alternatively, the functionality can be further integrated or even separated in terms of software. Alternatively, the functionality can be further combined in terms of hardware and software. The functionality can also be separated in terms of a combination of hardware and software. Depending upon the application, other variations can exist.

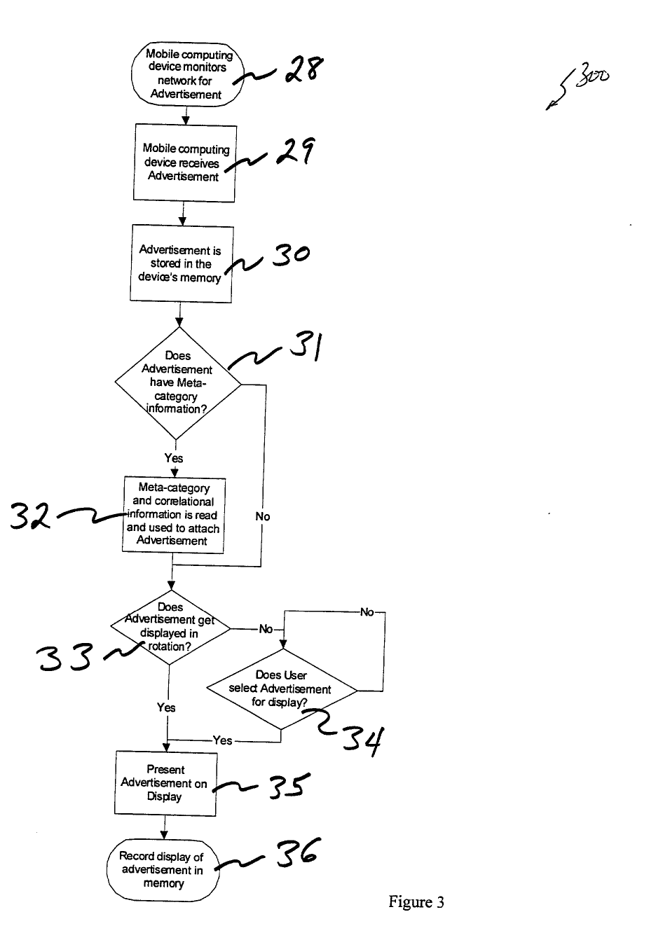

Referring to FIG. 3, the present invention provides a method 300 for receipt, storage, and display of an advertisement on a mobile communication device. Here, the mobile communication device monitors it's primary channel (or other channels or combination of channels) for receipt of a message addressed to it, step 26. In a specific embodiment, the channel may exist in multiple frequency bands dependent on carrier, inter-carrier, or international regulations or implementation, of which each frequency may contain multiple possible channels or the like. Accordingly, the present method provides for monitoring of a channel for message receipt.

The mobile communication device receives (step 29) a signal in its channel that contains an advertisement for it to present to the user. The advertisement is processed by the mobile communication device. In one embodiment, the method stores the advertisement in the memory storage device, step 30. Next, the method determines whether the advertisement includes meta-category information, step 31. If so, the mobile communication device processes the information packaged with the advertisement and extracts any metacategorizational or correlational information, step 32. The meta and correlational information is used by the device to attach the advertisement to the presently existing information in the device; advertisements, user behavior data, personalities, moods, events, activities, entertainment information, business information, etc.; allowing for the advertisement to be displayed if correlated information is presented to the user on the display. Alternatively, the method traverses to step 33, which is a decisional step. Here, the mobile communication device determines whether the advertisement is displayed in a rotation, step 33. If not, the method extracts information about the display of the rotation independent of correlation with other information in terms of frequency of usage of the device, and readies the advertisement for presentation.

That is, the advertisement is displayed, step 35. Alternatively, the mobile communication device then presents the advertisement on the display based on the non-correlated frequency of display of the advertisement or the display or correlated information, step 34. The user selects the advertisement for the display through a user interface device on the mobile communication device. Depending upon the embodiment, the selection process can be repeated indefinitely. Once the user selects the advertisement for display, the advertisement is displayed, step 35. Next, the method determines whether the advertisement should be stored. In a specific embodiment, the mobile communication device stores (step 36) information related to the presentation of the advertisement to the user.

Although the above has been described in terms of general hardware and software, many other variations, alternatives, and modifications can exist. For example, any of the functionality above can be further integrated or even separated in terms of hardware. Alternatively, the functionality can be further integrated or even separated in terms of software. Alternatively, the functionality can be further combined in terms of hardware and software. The functionality can also be separated in terms of a combination of hardware and software. Depending upon the application, other variations can exist.

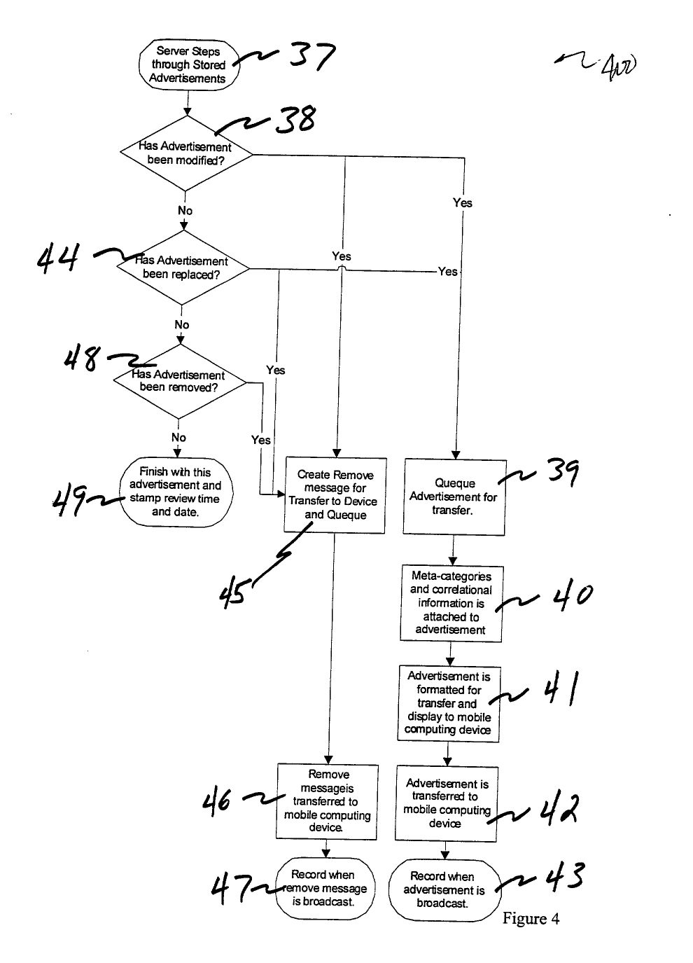

Referring to FIG. 4, the present invention provides a method 400 for modification, replacement, or removal of an advertisement from the backend system for transfer to the mobile communication device. Here, tools on the backend server reviews the advertisement information stored in the memory storage of the server, step 37. The method determines whether the advertisement has been modified, step 38. If so, the method continues to step 45 and/or step 39. If not, the method continues to step 44, where the method determines whether the advertisement has been replaced. If so, the method continues to step 45 and/or step 39. If not, the method continues to step 48, where the method determines whether the advertisement has been removed. If so, the method continues to step 45. If not, the method continues to step 49, where the method is finished with the advertisement and places a time and date stamp on the it.

The advertisement that has been modified (step 38) is queued (step 39) for the transfer of an update to the mobile communication device. Next, metacategorizational and correlational information is added (step 40) to the advertisement in the memory storage system, such as the positioning of the advertisement in relation to the already existing content, the planned presentation of the advertisement dependent or independent of the user's actions on the mobile communication device, etc. The backend system utilizes employees of the backend hosting company or automated tools to format and package (step 41) the advertisement and its related information for transfer to the network for further transfer to the mobile communication device. Next, the formatted and packaged information is then transferred (step 42) to the mobile communication device over the network. The transfer of the advertisement is recorded (step 43) for later tracking, auditing, and payment or crediting from the advertiser.

The advertisement that has been replaced (step 44) is queued (step 39) for transfer of a new advertisement to the mobile communication device. Metacategorizational and correlational information is added (step 40) to the advertisement in the memory storage system, such as the positioning of the advertisement in relation to the already existing content, the planned presentation of the advertisement dependent or independent of the user's actions on the mobile communication device, etc. The backend system utilizes employees of the backend hosting company or automated tools to format (step 41) and package the advertisement and its related information for transfer to the network for further transfer to the mobile communication device. The formatted and packaged information is then transferred (step 42) to the mobile communication device over the network. The transfer of the advertisement is recorded (step 43) for later tracking, auditing, and payment or crediting from the advertiser.

The advertisement that has been modified (step 38) or replaced (step 44), as noted, also undergoes a sequence of removal steps. Here, a message is also queued for the removal of the replaced advertisement for transfer to the mobile communication device. The removal message is packaged and transferred (step 46) to the mobile communication device over the network. The transfer of the advertisement removal message is recorded (step 47) for later tracking, auditing, and payment or crediting from the advertiser. The advertisement that has been removed (step 48) generates a removal message for transfer (step 46) to the mobile communication device. The removal message is packaged and transferred to the mobile communication device over the network. The transfer of the advertisement removal message is recorded (step 47) for later tracking, auditing, and payment or crediting from the advertiser.

Although the above has been described in terms of general hardware and software, many other variations, alternatives, and modifications can exist. For example, any of the functionality above can be further integrated or even separated in terms of hardware. Alternatively, the functionality can be further integrated or even separated in terms of software. Alternatively, the functionality can be further combined in terms of hardware and software. The functionality can also be separated in terms of a combination of hardware and software. Depending upon the application, other variations can exist.

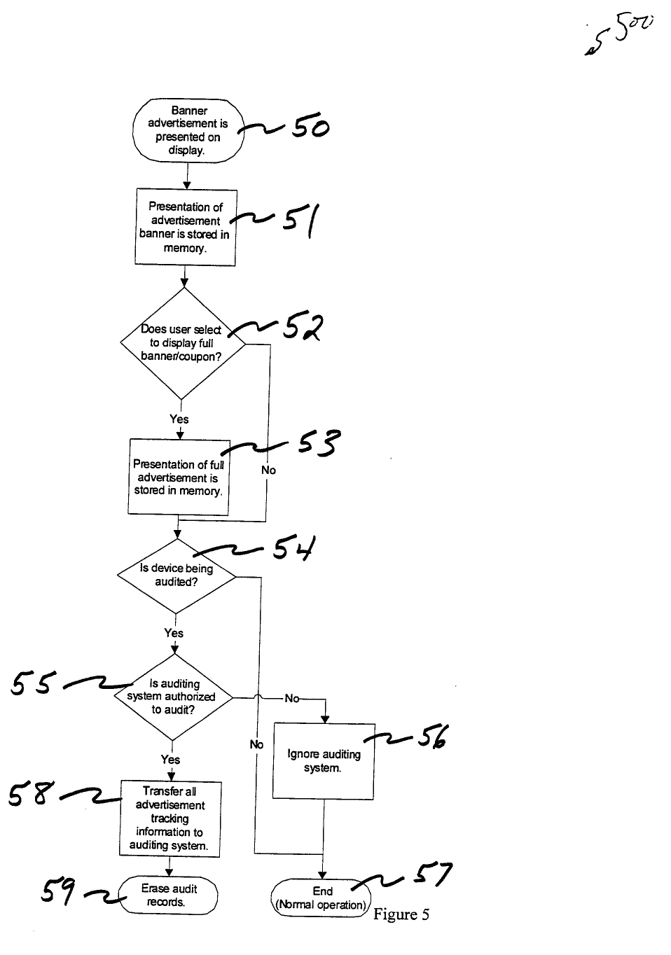

Referring to FIG. 5, the present invention provides a method 500 for display of an advertisement or coupon on the mobile communication device and storage and retrieval of audit information on the device. Here, the method provides for a small advertisement to be presented (step 50) to the user on the display based on the display of correlated information on the display at the request of the user or based on the decision of the system or the advertisement is displayed in a rotation unrelated to the other non-correlated information being presented on the display. Next; the presentation of the advertisement is stored (step 51) on the mobile communication device in the memory storage device for audit purposes.

The method determines (step 52) whether the user decides to select to display the advertisement, which may include a banner, coupon, or a combination thereof. If the user decides to select to present the advertisement of coupon that is related to the initial advertisement, the presentation of the advertisement is stored (step 53) on the mobile communication device in the memory storage device for audit purposes. The memory device is generally a volatile memory such as DRAM, Flash, and others. If not, the method continues to step 54, where the presentation is not stored. In step 54, the method determines whether the device is being audited.

If the device is not being audited, the method ignores the auditing system (step 56) and ends normal operation, step 57. Alternatively, the method senses an externally generated request for the transfer (step 58) or audit information or is scheduled to transfer the audit information to a backend or proxy system. The mobile communication device ascertains the validity of the externally generated request for the audit information before packaging the information to be transferred. If the external audit signal is valid or the scheduled transfer of audit information is allowed then the mobile communication device packages the audit information and any related information for transfer to the audit system or to a proxy for the audit system and sends the packaged information over the appropriate network. Next, the transferred audit information is removed (step 59) from the memory storage of the mobile communication device.

Although the above has been described in terms of general hardware and software, many other variations, alternatives, and modifications can exist. For example, any of the functionality above can be further integrated or even separated in terms of hardware. Alternatively, the functionality can be further integrated or even separated in terms of software. Alternatively, the functionality can be further combined in terms of hardware and software. The functionality can also be separated in terms of a combination of hardware and software. Depending upon the application, other variations can exist.

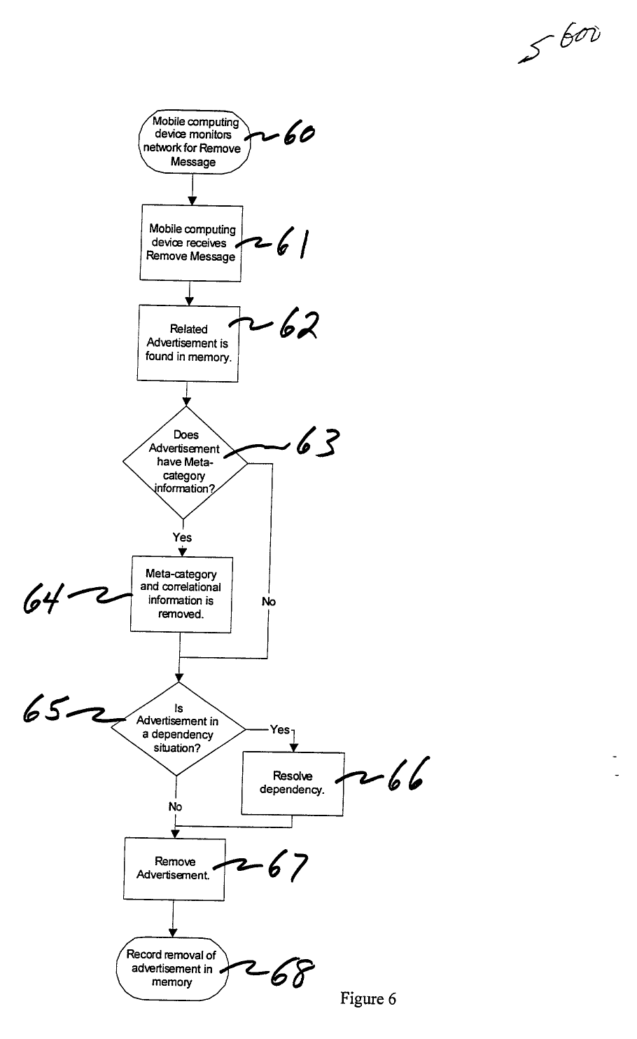

Referring to FIG. 6, the present invention provides a method 600 for receipt of an advertisement removal message and the actions often required to remove the advertisement along with all meta and correlational information as well as to resolve any dependency issues on the mobile communication device. Here, the mobile communication device monitors (step 60) it's primary channel (or other channel) for receipt of a removal message addressed to it. The channel may exist in multiple frequency bands dependent on carrier, inter-carrier, or international regulations or implementation, of which each frequency may contain multiple possible channels.

Next, the mobile communication device receives (step 61) a remove advertisement signal in its channel. The remove advertisement message is used by the mobile communication device to look for the related (step 62) advertisement in the memory storage device or the mobile communication device. Next, the method determines whether the advertisement has meta-category information, step 63. If not, the method continues to step 65. Alternatively, the mobile communication device looks for metacategorizational or correlational information attached to the advertisement in the memory storage device. The related meta or correlational information is removed (step 64) from the memory storage device.

In step 65, the method determines whether the advertisement is in a dependency situation or status. The mobile communication device looks for dependency information attached to the advertisement in the memory storage device. If a dependency is found, the dependency is resolved (step 66) by the mobile communication device such that the advertisement will not be referenced by unrelated advertisements, by related advertisements, be presented at any time during information presentation, be referenced by any non-correlated information, etc. If not, the method continues to step 67. In step 67, the method removes of the advertisement and related information. The removal of the advertisement is stored (step 68) in the memory storage of the mobile communication device for later auditing.

Although the above has generally been described in terms of specific hardware and methods, it would be recognized that many other types of hardware and methods could be used. For example, any of the functionality above can be further integrated or even separated in terms of hardware. Alternatively, the functionality can be further integrated or even separated in terms of software. Alternatively, the functionality can be further combined in terms of hardware and software. The functionality can also be separated in terms of a combination of hardware and software. Depending upon the application, other variations can exist.

Although the above has generally described the present invention according to specific systems, the present invention has a much broader range of applicability. In particular, the present invention is not limited to a particular kind of device, but can be applied to virtually any wireless or wired device where an understanding about the workings desired. Thus, in some embodiments, the techniques of the present invention could provide information about many different types of cells, substances, and genetic processes of all kinds. Of course, one of ordinary skill in the art would recognize other variations, modifications, and alternatives.

What is claimed is:

1. A mobile device for electronic commerce, the device comprising:
a mobile housing;
a microprocessor based unit coupled to a memory storage device in the housing;
a wireless receiver coupled to the microprocessor based unit, the wireless receiver being adapted to receiver information comprising text and graphics from a wireless network;
a display coupled to the housing and coupled to the microprocessor based unit; and
an advertisement comprising the text and graphics derived from the information and outputted on the display.

2. The device of claim 1 wherein the advertisement is selected from text, graphic, a banner, audio, video, or animation.

3. The device of claim 1 wherein the wireless network is selected from an rf network, a cellular network, a paging network, and an ir network.

4. The device of claim 1 wherein the device is selected from a pager, a cellular phone, a mobile radio, a personal digital assistant, a handheld computer, and a palm top computer.

5. The device of claim 1 wherein the memory device includes at least one megabytes of programmable memory to store the text and graphics.

6. The device of claim 5 wherein the programmable memory is selected from RAM, SRAM, Flash, and FRAM.

7. The device of claim 1 further comprising a transceiver coupled to the microprocessor based unit.

8. The device of claim 1 wherein the information is derived from a server.

9. A mobile device for electronic commerce, the device being coupled to an advertisement server, which is also coupled to other mobile devices, the mobile device comprising:
a mobile housing;
a microprocessor based unit coupled to a memory storage device in the housing;
a wireless receiver coupled to the microprocessor based unit, the wireless receiver being adapted to receiver information comprising text and graphics from a wireless network;
a display coupled to the housing and coupled to the microprocessor based unit;
an advertisement comprising the text and graphics derived from the information and outputted on the display, the advertisement being stored in the memory storage device; and
a control device in the mobile housing and coupled to the microprocessor, the control device being adapted to remove the advertisement from the memory storage device.

10. The mobile device of claim 9 wherein the control device comprises a button housed in the housing and coupled to the microprocessor through a input controller.

11. The mobile device of claim 9 wherein the advertisement being displayed on a lower edge portion of the display.

12. The mobile device of claim 9 wherein the advertisement being displayed on a first portion of the display and a message being displayed on a second portion of the display.

13. The mobile device of claim 9 wherein the advertisement server being adapted to transmit the advertisement to the plurality of mobile devices.

14. The mobile device of claim 9 wherein the memory device includes at least one megabytes of programmable memory to store the text and graphics.

15. The mobile device of claim 9 the advertisement is selected from text, graphic, a banner, audio, video, or animation.

16. A mobile paging device, the mobile paging device being free of a service charge to a user of the mobile paging device, the mobile paging device comprising:
a mobile housing;
a microprocessor based unit coupled to a memory storage device in the housing;
a wireless receiver coupled to the microprocessor based unit, the wireless receiver being adapted to receiver information comprising text and graphics from a wireless network;
a display coupled to the housing and coupled to the microprocessor based unit;
an advertisement comprising the text and graphics derived from the information and outputted on the display, the advertisement being stored in the memory storage device; and
a control device in the mobile housing and coupled to the microprocessor, the control device being adapted to remove the advertisement from the memory storage device;
wherein the advertisement is derived from an advertisement server, the advertisement server outputting the advertisement to pay for a portion of a service fee to a user of the mobile communication device.

17. The mobile device of claim 16 wherein the advertisement server being adapted to transmit the advertisement to a plurality of other mobile devices.

18. The mobile device of claim 16 wherein the control device comprises a button housed in the housing and coupled to the microprocessor through a input controller.

19. The mobile device of claim 16 wherein the advertisement being displayed on a first portion of the display and a message being displayed on a second portion of the display.

10. The mobile device of claim 19 wherein the display and the advertisement being outputted simultaneously.
